(19) United States
(12) Patent Application Publication
(10) Pub. No.: US 2025/0337329 A1
(43) Pub. Date: Oct. 30, 2025

(54) POWER CONVERTER WITH ACCURATE OUTPUT VOLTAGE FEEDBACK

(71) Applicant: Chengdu Monolithic Power Systems Co., Ltd., Chengdu (CN)

(72) Inventor: Xiangyi Yang, Chengdu, Sichuan (CN)

(21) Appl. No.: 19/187,121

(22) Filed: Apr. 23, 2025

(30) Foreign Application Priority Data
Apr. 24, 2024 (CN) 202410502690.4

(51) Int. Cl. H02M 3/335; H02M 1/36

(52) U.S. Cl. CPC H02M 3/33507; H02M 1/36

(57) ABSTRACT

A power converter with accurate output voltage feedback is discussed. The power converter has a feedback control circuit to sense a feedback voltage indicative of the output voltage at a time point after a calculated time length since the feedback voltage is pulled high. The calculated time length is generated by timing a duration that the feedback voltage is above a reference voltage.

### CROSS-REFERENCE TO RELATED APPLICATIONS

This application claims priority to and the benefit of Chinese Patent Application No. 202410502690.4, filed Apr. 24, 2024, which is incorporated herein by reference in its entirety.

### BACKGROUND OF THE INVENTION

Isolated power circuits such as flyback converter and forward converter are widely used in power conversion fields, to convert an input voltage to a desired output voltage. Since there is an isolation between the primary side and the secondary side, the output voltage needs to be sensed to perform voltage regulations if primary side control is adopted. Even when the circuit adopts secondary side control, the output voltage needs to be sensed to perform protections such as over voltage protection, undervoltage protection, and etc.

Prior art typically uses an auxiliary winding (i.e., a third winding) to sense the output voltage: a voltage across the auxiliary winding is sensed as a feedback voltage of the output voltage after a fixed delay since the voltage across the auxiliary winding is pulled high. Then the feedback voltage is delivered to the control loop, to perform voltage regulation or protection.

However, the feedback voltage may vary fast if the secondary side has a large current, resulting in an inaccuracy of the feedback voltage, i.e. the feedback voltage may not reflect the real output voltage, which may cause a circuit fault.

### SUMMARY OF THE INVENTION

In accordance with an embodiment of the present invention, a power converter is discussed. The power converter comprises: a transformer having a primary winding, configured to receive an input voltage; a second winding, configured to provide an output voltage to a load; and a third winding, configured to generate a feedback voltage indicative of the output voltage. The power converter further comprises: a main power switch and a feedback control circuit. The main power switch is configured to be periodically turned on and off, to convert the input voltage to the output voltage. The feedback control circuit is configured to receive the feedback voltage, to generate a control signal, to control the main power switch. The feedback control circuit comprises: a voltage detect circuit, a timing circuit, and a first delay circuit. The voltage detect circuit is configured to detect whether the feedback voltage is pulled high, to generate a detect signal. The timing circuit is configured to time a duration that the feedback voltage is higher than a reference voltage, to generate a calculated time length. The first delay circuit is configured to delay the detect signal for the calculated time length since a time point that the feedback voltage is pulled high, to generate a calculated delay signal.

In addition, in accordance with an embodiment of the present invention, a feedback control circuit is discussed. The feedback control circuit comprises: a voltage detect circuit, a timing circuit, and a first delay circuit. The voltage detect circuit is configured to detect whether a feedback voltage indicative of an output voltage of a power converter is pulled high, to generate a detect signal. The timing circuit is configured to time a duration that the feedback voltage is higher than a reference voltage, to generate a calculated time length. The first delay circuit is configured to delay the detect signal for the calculated time length since a time point that the feedback voltage is pulled high, to generate a calculated delay signal.

Furthermore, in accordance with an embodiment of the present invention, a method used in a power converter is discussed. The power converter including a primary winding configured to receive an input voltage, a secondary winding configured to provide an output voltage, and a third winding configured to provide a feedback voltage indicative of the output voltage. The method comprising: detecting whether the feedback voltage is pulled high; and detecting a state of the power converter: If the power converter is at a startup process or operates at a transient state, sensing the feedback voltage at a time point after a fixed time length since the feedback voltage is pulled high; and if the power converter completes the startup process or operates at a steady state, sensing the feedback voltage at a time point after a calculating time length since the feedback voltage.

### BRIEF DESCRIPTION OF DRAWINGS

FIG. 1 schematically shows a power converter 100 in accordance with an embodiment of the present invention.

FIG. 2 schematically shows a power converter 200 in accordance with an embodiment of the present invention.

FIG. 3 schematically shows a power converter 300 in accordance with an embodiment of the present invention.

FIG. 4 schematically shows a flowchart 400 of a method used in a power converter in accordance with an embodiment of the present invention.

### DETAILED DESCRIPTION OF THE INVENTION

Embodiments of circuits for power converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

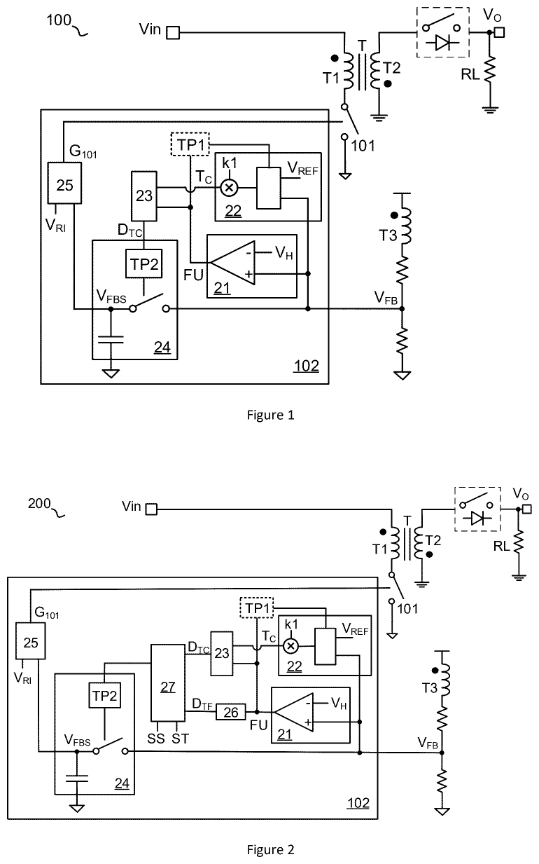

FIG. 1 schematically shows a power converter 100 in accordance with an embodiment of the present invention. In the example of FIG. 1, the power converter 100 comprises: a transformer T, having a primary winding T1, a secondary winding T2, and a third winding T3. The primary winding T1 is configured to receive an input voltage Vin. The second winding T2 is configured to provide an output voltage Vo to a load RL. The third winding T3 is configured to generate a feedback voltage V_{FB} indicative of the output voltage Vo. The power converter 100 further comprises: a main power switch 101 and a feedback control circuit 102. The main power switch 101 is configured to be periodically turned on and off, to convert the input voltage Vin to the output voltage Vo. The feedback control circuit 102 is coupled to the third winding T3, to receive the feedback voltage V_{FB}, to generate a control signal G₁₀₁, which is used to control the main power switch 101.

The feedback control circuit 102 comprises: a voltage detect circuit 21, a timing circuit 22, a first delay circuit 23, a sample-hold circuit 24, and a regulation circuit 25. The voltage detect circuit 21 is configured to detect whether the feedback voltage V_{FB} is pulled high, to generate a detect signal FU. The timing circuit 22 is configured to time a duration that the feedback voltage V_{FB} is higher than a reference voltage V_{REF}, to generate a calculated time length T_{C}. That is, the calculated time length is indicative of the duration the feedback voltage V_{FB} is higher than a reference voltage V_{REF}. The first delay circuit 23 is configured to delay the detect signal FU for the calculated time length T_{C} since the time point that the feedback voltage V_{FB} is pulled high, to generate a calculated delay signal D_{TC}. The sample-hold circuit 24 is configured to sample and hold the feedback voltage V_{FB} in response to the calculated delay signal D_{TC}, to generate a sampled voltage V_{FBS}. The regulation circuit 25 is configured to generate the control signal G 101 in response to the sampled voltage V_{FBS}. The timing circuit 22 is further configured to reset the calculated time length T_{C} after a short time delay (e.g., a short pulse delay) since the time point the feedback voltage V_{FB} is pulled high, and restart timing the duration the feedback voltage V_{FB} is above the reference voltage V_{REF} in the present switching cycle, to generate a refreshed calculated time length T_{C}, which is delivered to the first delay circuit 23 at the next switching cycle after the feedback voltage V_{FB} is pulled high. In the example of FIG. 1, t the detect signal FU is delivered to the timing circuit 22 via a short pulse circuit TP1. However, one skilled in the art should realize that the detect signal FU may be delivered to the timing circuit 22 directly with no short pulse circuit TP1, since the circuit has inherent delay during signal transition. As shown in FIG. 1, the short pulse circuit TP1 is shown with dashed line.

In one embodiment of the present invention, the timing circuit 22 is further configured to multiply the duration the feedback voltage V_{FB} is above the reference voltage V_{REF} with a coefficient k1, to generate the calculated time length T_{C}. The coefficient k1 may have a value close to 1, e.g., K1 may set to be 0.9.

In one embodiment of the present invention, the timing circuit 22 is configured to start timing when the feedback voltage V_{FB} increases to be higher than the reference voltage V_{REF}, and stop timing when the feedback voltage V_{FB} decreases to be lower than the reference voltage V_{REF}, to obtain the duration the feedback voltage V_{FB} is above the reference voltage V_{REF}.

In one embodiment of the present invention, the voltage detect circuit 21 comprises a comparator, configured to compare the feedback voltage V_{FB} with a voltage threshold V_{H}. When the feedback voltage V_{FB} is higher than the voltage threshold V_{H}, it indicates the feedback voltage V_{FB} is pulled high.

In one embodiment of the present invention, the sample-hold circuit 24 comprises: a short pulse circuit TP2, configured to generate a short pulse signal in response to the calculated delay signal D_{TC}; and a sample-hold unit (including a sample switch and a hold capacitor as shown in FIG. 1), configured to sample and hold the feedback voltage V_{FB} in response to the short pulse signal, to provide the sampled voltage V_{FBS}.

In one embodiment of the present invention, the regulation circuit 25 is configured to regulate the sampled voltage V_{FBS} to an internal voltage reference V_{R1}, to regulate the output voltage Vₒ to a desired voltage value.

In one embodiment of the present invention, the reference voltage V_{REF} is proportional to the internal voltage reference V_{R1}, e.g., V_{REF}=k2*VR1. K2 is a coefficient closes to 1. For example, k2 may be set to be 0.95.

During the operation of the power converter 100, at each switching cycle, the timing circuit 22 is configured to deliver the calculated time length T_{C} obtained in the last switching cycle to the first delay circuit 23. The feedback voltage V_{FB} is pulled high after the main power switch 101 is turned off. On one hand, the first delay circuit 23 is configured to generate the calculated delay signal D_{TC} after delaying for the calculated time length since the time point the feedback voltage V_{FB} is pulled high. Accordingly, the short pulse circuit TP2 is configured to generate the short pulse signal to have the sample-hold unit sample and hold the feedback voltage to obtain the sampled voltage V_{FBS}. Then the sampled voltage V_{FBS} is delivered to the regulation circuit 25, which generates the control signal G 101 to control the main power switch 101, so as to regulate the output voltage Vₒ or to perform protection actions. On the other hand, after a short time delay since the time point the feedback voltage V_{FB} is pulled high, the timing circuit 22 is configured to reset the current calculated time length T_{C}, and to restart timing the duration the feedback voltage V_{FB} is above the reference voltage V_{REF} in the present switching cycle, to obtain a refreshed duration. Then the refreshed duration is multiplied by the coefficient K1, to generate the refreshed calculated time length T_{C}, which is delivered to the first delay circuit 23, so that the first delay circuit 23 is configured to delay for the updated calculated time length since the time point the feedback voltage V_{FB} is pulled high in the next switching cycle. The power converter 100 operates as discussed above in each switching cycle, to obtain a time point to sense the feedback voltage V_{FB}, so as to feed back the accurate output voltage to the control loop.

FIG. 2 schematically shows a power converter 200 in accordance with an embodiment of the present invention. The power converter 200 in FIG. 2 is similar to the power converter 100 in FIG. 1, with a difference that in the example of FIG. 2, the feedback control circuit 102 further comprises: a second delay circuit 26 and a select circuit 27. The second delay circuit is configured to delay the detect signal FU for a fixed time length T_{DF} since the time point the feedback voltage V_{FS} is pulled high, to generate a fixed delay signal D_{TF}. The select circuit 27 is configured to deliver the fixed delay signal DTF to the sample-hold circuit 24 when the power converter 200 is at a startup process (e.g., when a startup signal SS is logical high (1)) or when the power converter 200 operates at a transient state (e.g., when the load RL has a sudden change, and a status signal ST is logical high (1)), so that the sample-hold circuit 24 is configured to sample and hold the feedback voltage V_{FB} after the fixed time length since the time point the feedback voltage V_{FB} is pulled high. That is, the feedback voltage V_{FB} is sampled and held as the sampled voltage signal V_{FBS} after the fixed time length since the time point the feedback voltage V_{FB} is pulled high. The select circuit 27 is further configured to deliver the calculated delay signal D_{TC} to the sample-held circuit 24 when the power converter completes the startup process (e.g. when the startup signal SS is low (0)) or when the power converter 200 operates at a steady state (e.g., when the state signal ST is logical low (0)), so that the sample-hold circuit 24 is configured to sample and hold the feedback voltage V_{FB} after the calculated time length since the time point the feedback voltage V_{FB} is pulled high. That is, the feedback voltage V_{FB} is sampled and held as the sampled voltage signal V_{FBS} after the calculated time length since the time point the feedback voltage V_{FB} is pulled high.

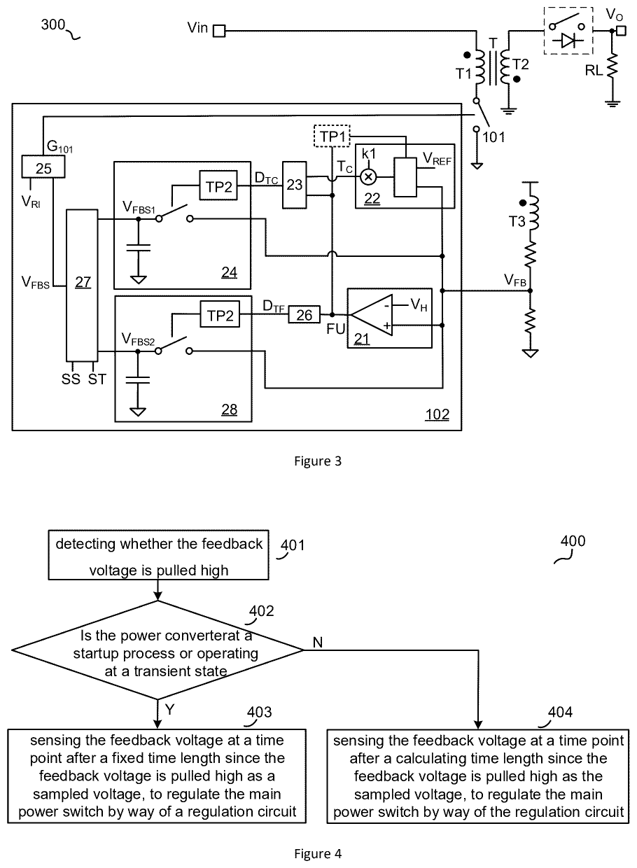

FIG. 3 schematically shows a power converter 300 in accordance with an embodiment of the present invention. The power converter 300 in FIG. 3 is similar to the power converter 100 in FIG. 1, with a difference that in the example of FIG. 3, the feedback control circuit 102 comprises: a voltage detect circuit 21, a timing circuit 22, a first delay circuit 23, a first sample-hold circuit 24, a second delay circuit 26, a second sample-hold circuit 28, and a select circuit 27. The voltage detect circuit 21 is configured to detect whether the feedback voltage V_{FB} is pulled high, to generate a detect signal FU. The timing circuit 22 is configured to time a duration that the feedback voltage V_{FB} is higher than a reference voltage V_{REF}, to generate a calculated time length T_{C}. The first delay circuit 23 is configured to delay the detect signal FU for the calculated time length T_{C} since the time point the feedback voltage V_{FB} is pulled high, to generate a calculated delay signal D_{TC}. The first sample-hold circuit 24 is configured to sample and hold the feedback voltage V_{FB} in response to the calculated delay signal D_{TC}, to generate a first sampled voltage V_{FBS1}. The second delay circuit 26 is configured to delay the detect signal FU for a fixed time length since the time point the feedback voltage V_{FB} is pulled high, to generate a fixed delay signal DTF. The second sample-hold circuit 28 is configured to sample and hold the feedback voltage V_{FB} in response to the fixed delay signal DTF, to generate a second sampled voltage V_{FBS2}. The select circuit 27 is configured to select the first sample voltage V_{FBS1} as the sampled voltage V_{FBS} when the power converter 300 is at the startup process or when the power converter 300 operates at the transient state. That is, when the power converter 300 is at the startup process or when the power converter 300 operates at the transient state, the feedback voltage V_{FB} at a time point after the fixed time length since the time point the feedback voltage V_{FB} is pulled high is sampled and held as the sampled voltage signal V_{FBS}. The select circuit 27 is further configured to select the second sampled voltage V_{FBS2} as the sampled voltage V_{FBS} When the power converter completes the startup process or when the power converter 300 operates at the steady state. That is, when the power converter completes the startup process or when the power converter 300 operates at the steady state, the feedback voltage V_{FB} at a time point after the calculated time length since the time point the feedback voltage V_{FB} is pulled high is sampled and held as the sampled voltage signal V_{FBS}.

During the operation of the power converter 200 and/or 300, when the power converter is at the startup process or when the power converter is at the transient state due to a sudden load change, the feedback voltage V_{FB} at the time point after the fixed time length since being pulled high is sensed and sampled, and is delivered to the regulation circuit as the sampled voltage. Thus, the output voltage Vₒ is fed back to the regulation circuit rapidly. When the power converter completes the startup process or when the power converter is at the steady state, the feedback voltage V_{FB} at the time point after the calculated time length since being pulled high is sensed and sampled, and is delivered to the regulation circuit as the sampled voltage. Thus, the output voltage Vₒ is fed back to the regulation circuit with a better accuracy.

FIG. 4 schematically shows a flowchart 400 of a method used in a power converter in accordance with an embodiment of the present invention. The power converter comprises: a main power switch, a primary winding configured to receive an input voltage, a secondary winding configured to provide an output voltage, and a third winding configured to provide a feedback voltage indicative of the output voltage. The method comprises:

Step 401, detecting whether the feedback voltage is pulled high. In one embodiment of the present invention, the feedback voltage is compared to the voltage threshold: if the feedback voltage is above the voltage threshold, indicating the feedback voltage is pulled high.

Step 402, detecting a state of the power converter: at a startup process or operating at a transient state. If the power converter is at the startup process or operates at a transient state, going to step 403; otherwise, if the power converter completes the startup process or operates at a steady state, going to step 404.

Step 403, sensing the feedback voltage at a time point after a fixed time length since the feedback voltage is pulled high as a sampled voltage, to regulate the main power switch by way of a regulation circuit.

Step 404, sensing the feedback voltage at a time point after a calculating time length since the feedback voltage is pulled high as the sampled voltage, to regulate the main power switch by way of the regulation circuit.

In one embodiment of the present invention, the method further comprising: when the power converter completes the startup process or when the power converter operates at the steady state, timing a duration the feedback voltage is above a voltage reference, to obtain a time length; multiplying the time length with a coefficient, to generate the calculated time length.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A power converter, comprising:
a transforming having: a primary winding, configured to receive an input voltage; a second winding, configured to provide an output voltage to a load; and a third winding, configured to generate a feedback voltage indicative of the output voltage;
a main power switch, configured to be periodically turned on and off, to convert the input voltage to the output voltage; and
a feedback control circuit, configured to receive the feedback voltage, to generate a control signal, to control the main power switch, wherein the feedback control circuit comprises:
a voltage detect circuit, configured to detect whether the feedback voltage is pulled high, to generate a detect signal;
a timing circuit, configured to time a duration that the feedback voltage is higher than a reference voltage, to generate a calculated time length; and
a first delay circuit, configured to delay the detect signal for the calculated time length since a time point that the feedback voltage is pulled high, to generate a calculated delay signal.

2. The power converter of claim 1, wherein
the timing circuit is configured to start timing when the feedback voltage increases to be higher than the reference voltage, and stop timing when the feedback voltage decreases to be lower than the reference voltage, to obtain the duration the feedback voltage is above the reference voltage; and wherein
the duration is multiplied with a coefficient to generate the calculated time length.

3. The power converter of claim 1, wherein the feedback control circuit further comprises:
a sample-hold circuit, configured to sample and hold the feedback voltage in response to the calculated delay signal, to generate a sampled voltage; and
a regulation circuit, configured to generate the control signal in response to the sampled voltage.

4. The power converter of claim 1, wherein the feedback control circuit further comprises:
a second delay circuit, configured to delay the detect signal for a fixed time length since the time point the feedback voltage is pulled high, to generate a fixed delay signal;
wherein
the feedback voltage is sensed at a time point 1) after the fixed time length since the feedback voltage is pulled high when the power converter is at a startup process or operates at a transient state; and 2) after the calculated time length since the feedback voltage is pulled high when the power converter completes the startup process or operates at a steady state.

5. The power converter of claim 1, wherein the feedback control circuit further comprises:
a second delay circuit, configured to delay the detect signal for a fixed time length since the time point the feedback voltage is pulled high, to generate a fixed delay signal;
a first sample-hold circuit, configured to sample and hold the feedback voltage in response to the calculated delay signal, to generate a first sampled voltage; and
a second sample-hold circuit, configured to sample and hold the feedback voltage in response to the fixed delay signal, to generate a second sampled voltage.

6. The power converter of claim 5, wherein the feedback control circuit further comprises:
a select circuit, configured to select 1) the first sample voltage as a sampled voltage to be delivered to a regulation circuit when the power converter is at a startup process or when the power converter operates at a transient state, and 2) the second sampled voltage as the sampled voltage to be delivered to the regulation circuit when the power converter completes the startup process or when the power converter operates at a steady state.

7. The power converter of claim 1, wherein
the timing circuit is configured to reset the calculated time length after a short time delay since the time point the feedback voltage is pulled high, and restart timing the duration the feedback voltage is above the reference voltage in a present switching cycle, to generate a refreshed calculated time length.

8. A feedback control circuit, comprising:
a voltage detect circuit, configured to detect whether a feedback voltage indicative of an output voltage of a power converter is pulled high, to generate a detect signal;
a timing circuit, configured to time a duration that the feedback voltage is higher than a reference voltage, to generate a calculated time length; and
a first delay circuit, configured to delay the detect signal for the calculated time length since a time point that the feedback voltage is pulled high, to generate a calculated delay signal.

9. The feedback control circuit of claim 8, wherein
the timing circuit is configured to start timing when the feedback voltage increases to be higher than the reference voltage, and stop timing when the feedback voltage decreases to be lower than the reference voltage, to obtain the duration the feedback voltage is above the reference voltage; and wherein
the duration is multiplied with a coefficient to generate the calculated time length.

10. The feedback control circuit of claim 8, further comprising:
a sample-hold circuit, configured to sample and hold the feedback voltage in response to the calculated delay signal, to generate a sampled voltage; and
a regulation circuit, configured to generate a control signal in response to the sampled voltage.

11. The feedback control circuit of claim 8, further comprising:
a second delay circuit, configured to delay the detect signal for a fixed time length since the time point the feedback voltage is pulled high, to generate a fixed delay signal;
wherein the feedback voltage is sensed at a time point 1) after the fixed time length since the feedback voltage is pulled high when the power converter is at a startup process or operates at a transient state; and 2) after the calculated time length since the feedback voltage is pulled high when the power converter completes the startup process or operates at a steady state.

12. The feedback control circuit of claim 8, further comprising:
a second delay circuit, configured to delay the detect signal for a fixed time length since the time point the feedback voltage is pulled high, to generate a fixed delay signal;
a first sample-hold circuit, configured to sample and hold the feedback voltage in response to the calculated delay signal, to generate a first sampled voltage;
a second sample-hold circuit, configured to sample and hold the feedback voltage in response to the fixed delay signal, to generate a second sampled voltage.

13. The feedback control circuit of claim 12, further comprising:
a select circuit, configured to select 1) the first sample voltage as a sampled voltage to be delivered to a regulation circuit when the power converter is at a startup process or when the power converter operates at a transient state, and 2) the second sampled voltage as the sampled voltage to be delivered to the regulation circuit when the power converter completes the startup process or when the power converter operates at a steady state.

14. The feedback control circuit of claim 8, wherein
the timing circuit is configured to reset the calculated time length after a short time delay since the time point the feedback voltage is pulled high, and restart timing the duration the feedback voltage is above the reference voltage in a present switching cycle, to generate a refreshed calculated time length.

15. A method used in a power converter, the power converter including a primary winding configured to receive an input voltage, a secondary winding configured to provide an output voltage, and a third winding configured to provide a feedback voltage indicative of the output voltage, the method comprising:
detecting whether the feedback voltage is pulled high; and
detecting a state of the power converter: If the power converter is at a startup process or operates at a transient state, sensing the feedback voltage at a time point after a fixed time length since the feedback voltage is pulled high; and if the power converter completes the startup process or operates at a steady state, sensing the feedback voltage at a time point after a calculating time length since the feedback voltage.

16. The method of claim 15, wherein
the feedback voltage is sensed as a sampled voltage, to regulate a main power switch in the power converter by way of a regulation circuit.

17. The method of claim 15, wherein
the feedback voltage is compared to a voltage threshold to detect whether the feedback voltage is pulled high.

18. The method of claim 15, further comprising:
timing a duration the feedback voltage is above a voltage reference, to obtain a time length; and
multiplying the time length with a coefficient, to generate the calculated time length when the power converter completes the startup process or when the power converter operates at the steady state.
